(19) United States
(12) Patent Application Publication
(10) Pub. No.: US 2021/0234911 A1
(43) Pub. Date: Jul. 29, 2021

(54) MODIFYING MULTIMEDIA BASED ON USER CONTEXT

(71) Applicant: INTERNATIONAL BUSINESS MACHINES CORPORATION, Armonk, NY (US)

(72) Inventors: Scott Carrier, Apex, NC (US); Andrew G. Hicks, Raleigh, NC (US); BRENDAN Bull, Durham, NC (US); Dwi Sianto Mansjur, Cary, NC (US); Paul Lewis Felt, Springville, UT (US)

(21) Appl. No.: 16/752,724

(22) Filed: Jan. 27, 2020

(51) Int. Cl. H04L 29/06; G06F 16/44; H04L 29/08

(52) U.S. Cl. CPC H04L 65/601; H04L 67/22; G06F 16/44

(57) ABSTRACT

The exemplary embodiments disclose a system and method, a computer program product, and a computer system for modifying multimedia. The exemplary embodiments may include receiving a multimedia and one or more inputs, determining a required amount of modification to the multimedia based on the one or more inputs, generating a literary parse tree based on the multimedia, extracting one or more node features from one or more nodes of the parse tree, determining a node importance of the one or more nodes based on applying a model to the one or more node features, and modifying one or more portions of the multimedia corresponding to the one or more nodes based on the node importance and the required amount of multimedia modification.

### BACKGROUND

The exemplary embodiments relate generally to modifying multimedia, and more particularly to modifying multimedia based on user context.

People frequently need to read, listen to, or watch multimedia within a given time constraint, and often need to do so in a shorter amount of time than it would take for them to read, listen to, or watch the multimedia in its entirety. It can be difficult to determine which chapters, sections, or groups of multimedia are the most important or should be most prioritized. For example, a person may desire to read the entirety of an article that normally requires an hour to read, but the person's schedule may only allow for forty-five minutes of reading. The person would undoubtedly struggle to find and read the most important portions of the article to efficiently utilize their forty-five minutes of reading.

### SUMMARY

The exemplary embodiments disclose a system and method, a computer program product, and a computer system for modifying multimedia. The exemplary embodiments may include receiving a multimedia and one or more inputs, determining a required amount of modification to the multimedia based on the one or more inputs, generating a literary parse tree based on the multimedia, extracting one or more node features from one or more nodes of the parse tree, determining a node importance of the one or more nodes based on applying a model to the one or more node features, and modifying one or more portions of the multimedia corresponding to the one or more nodes based on the node importance and the required amount of multimedia modification.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of a multimedia modification system 100, in accordance with the exemplary embodiments.

FIG. 2 depicts an exemplary flowchart 200 illustrating the operations of a multimedia modifier 134 of the multimedia modification system 100 in modifying multimedia, in accordance with the exemplary embodiments.

FIG. 3 depicts an illustrative example of a literary parse tree generated by the multimedia modification system 100 based on received multimedia, in accordance with the exemplary embodiments.

FIG. 4 depicts an illustrative example of the literary parse tree in which the multimedia modifier 134 has assigned nodes importance scores, in accordance with the exemplary embodiments.

FIG. 5 depicts an exemplary block diagram depicting the hardware components of the multimedia modification system 100 of FIG. 1, in accordance with the exemplary embodiments.

FIG. 6 depicts a cloud computing environment, in accordance with the exemplary embodiments.

FIG. 7 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

People frequently need to read, listen to, or watch multimedia within a given time constraint, and often need to do so in a shorter amount of time than it would take for them to read, listen to, or watch the multimedia in its entirety. It can be difficult to determine which chapters, sections, or groups of multimedia are the most important. For example, a person may desire to read the entirety of an article that normally requires an hour to read, but the person's schedule may only allow for forty-five minutes of reading. The person would undoubtedly struggle to find and read the most important portions of the article to efficiently utilize their forty-five minutes of reading. In another example, a user may wish to absorb a thirty minute video in only twenty minutes of time, or listen to an hour long podcast during a forty-five minute workout.

Hence, an independent system is needed to address the aforementioned problem. Exemplary embodiments of the present invention disclose a method, computer program product, and computer system that will modify multimedia based on user inputs. Accordingly, example embodiments are directed to a system that will modify multimedia received in audio, video, typed, virtual reality, augmented reality, etc. form. In embodiments, audio processing, video processing, and other data processing methods may be used to modify multimedia. In particular, example embodiments may be configured for analyzing audio (e.g., speech), video (e.g., facial features), and other contextual features in order to determine an importance of and trim, skip, fast forward, etc. portions of the analyzed multimedia. Use cases of embodiments described herein may relate to improvement of, for example, but not limited to, an efficiency of experiencing multimedia such as books, articles, PDFs, etc., the modification of audio works such as audiobooks, audio lectures, audio podcasts, etc., and the modification of video works such as movies, video lectures, video blogs, etc. In general, it will be appreciated that embodiments described herein may relate to multimedia modification for any type of media.

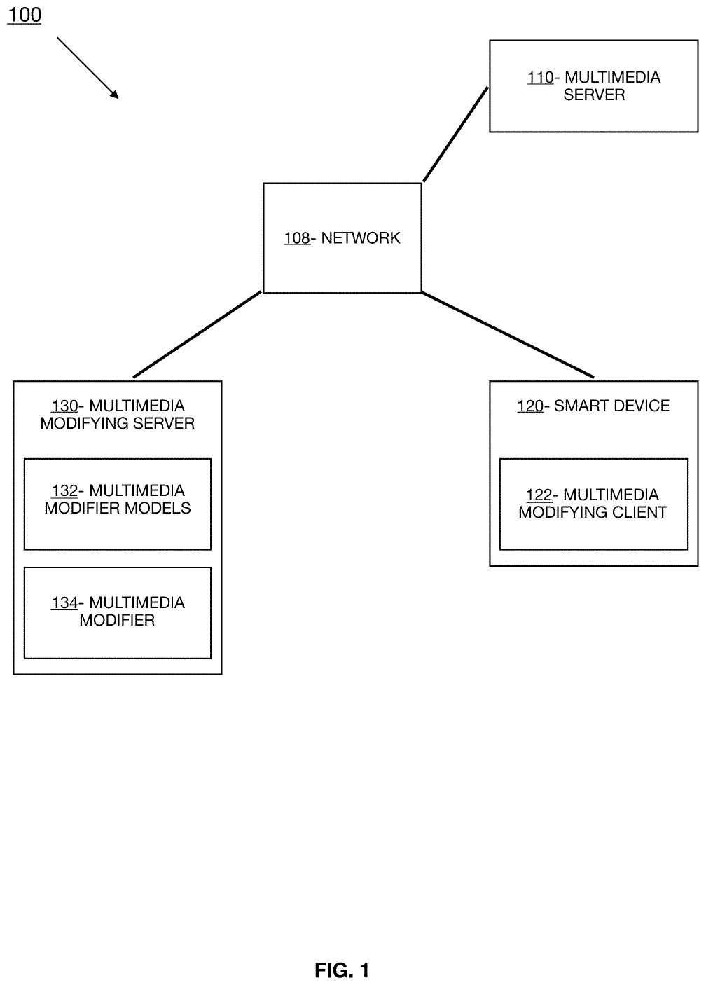

FIG. 1 depicts the multimedia modification system 100, in accordance with the exemplary embodiments. According to the exemplary embodiments, the multimedia modification system 100 may include a multimedia server 110, a smart device 120 and a multimedia modifying server 130, which may be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted.

In the exemplary embodiments, the network 108 may be a communication channel capable of transferring data between connected devices. Accordingly, the components of the multimedia modification system 100 may represent network components or network devices interconnected via the network 108. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc. which may be implemented as an intranet network, a local area network (LAN), a wide area network (WAN), or a combination thereof. In further embodiments, the network 108 may be a Bluetooth network, a Wi-Fi network, or a combination thereof. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices.

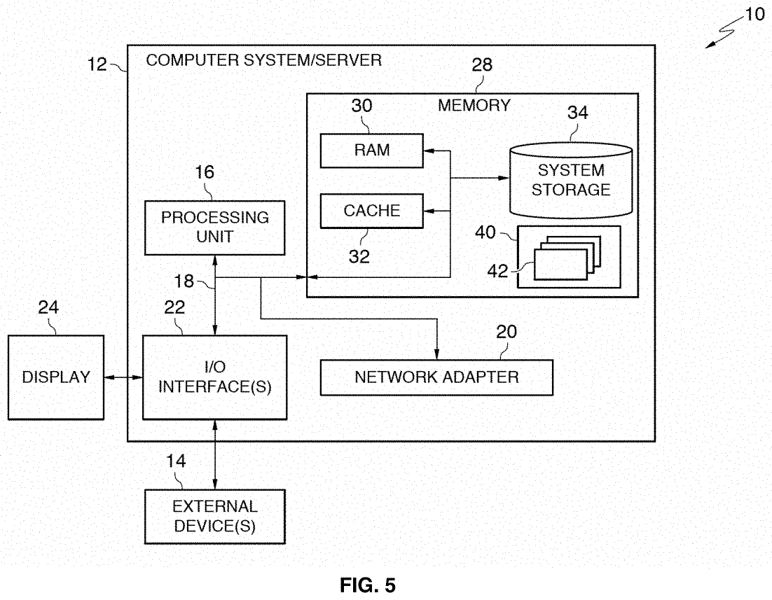

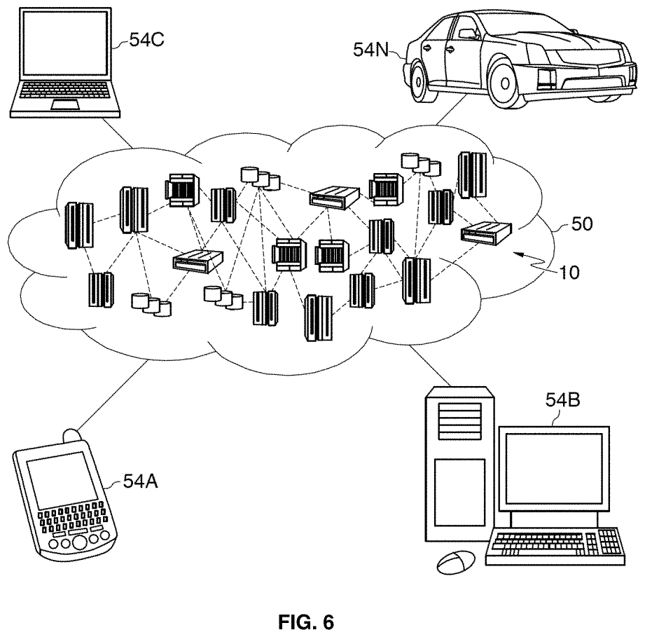

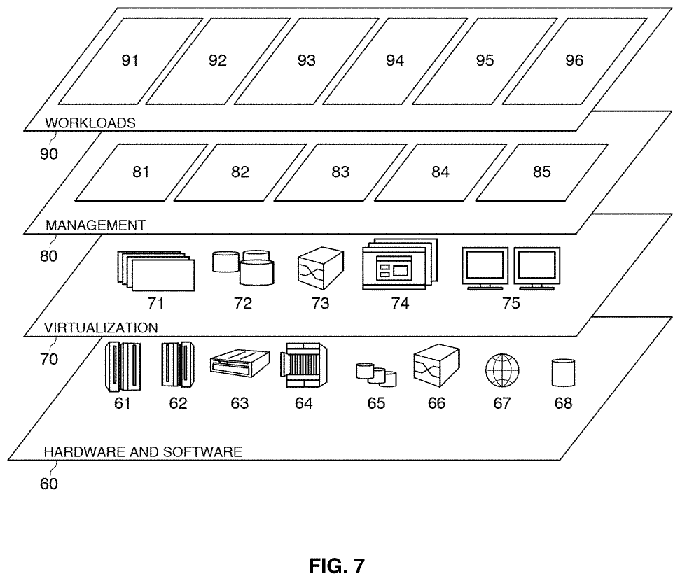

In the exemplary embodiments, the multimedia server 110 may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of receiving and sending data to and from other computing devices. While the multimedia server 110 is shown as a single device, in other embodiments, the multimedia server 110 may be comprised of a cluster or plurality of computing devices, working together or working independently. In some embodiments, the multimedia server 110 may include one or more storage mediums and act as a repository for multimedia of various forms, for example audio, video, text, etc. In addition, the multimedia server 110 may be configured for transferring the multimedia to the smart device 120 and/or multimedia modifying server 130 via the network 108. The multimedia server 110 is described in greater detail as a hardware implementation with reference to FIG. 5, as part of a cloud implementation with reference to FIG. 6, and/or as utilizing functional abstraction layers for processing with reference to FIG. 7.

In the example embodiment, the smart device 120 includes a multimedia modifying client 122, and may be an enterprise server, laptop computer, notebook, tablet computer, netbook computer, personal computer (PC), desktop computer, server, personal digital assistant (PDA), rotary phone, touchtone phone, smart phone, mobile phone, virtual device, thin client, IoT device, or any other electronic device or computing system capable of receiving and sending data to and from other computing devices. In embodiments, the smart device 120 may be comprised of a cluster or plurality of computing devices, in a modular manner, etc., working together or working independently. The smart device 120 is described in greater detail as a hardware implementation with reference to FIG. 5, as part of a cloud implementation with reference to FIG. 6, and/or as utilizing functional abstraction layers for processing with reference to FIG. 7.

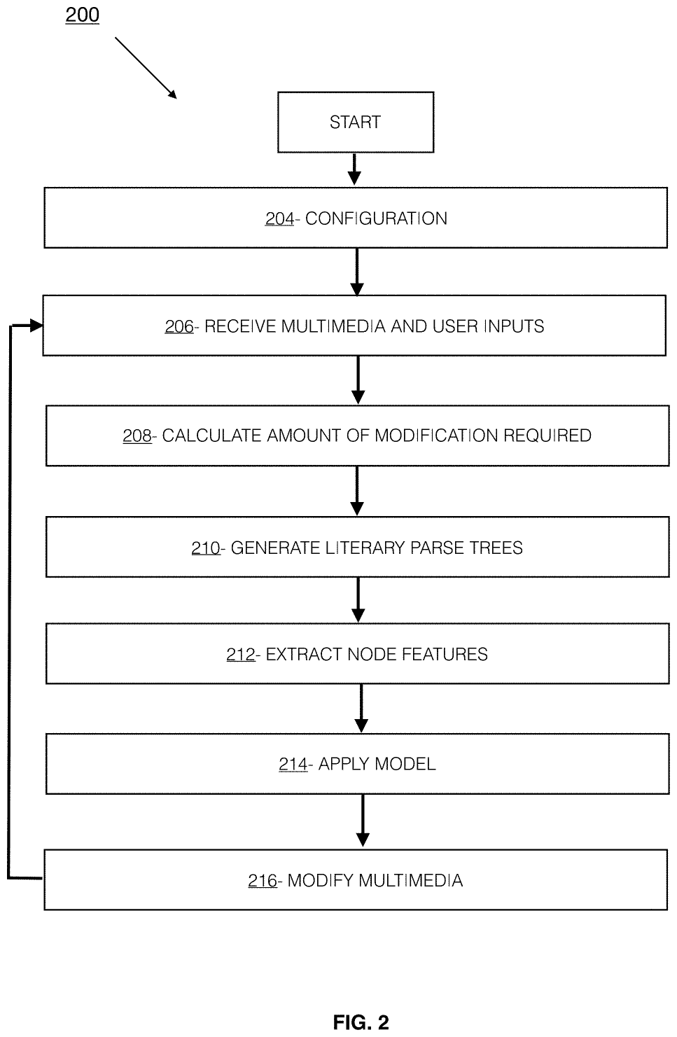

The multimedia modifying client 122 may act as a client in a client-server relationship, and may be a software and/or hardware application capable of communicating with and providing a user interface for a user to interact with a server via the network 108. Moreover, in the example embodiment, the multimedia modifying client 122 may be capable of transferring data from the smart device 120 to other devices such as the multimedia modifying server 130 or multimedia server 110 via the network 108. In embodiments, the multimedia modifying client 122 utilizes various wired and wireless connection protocols for data transmission and exchange, including Bluetooth, 2.4 gHz and 5 gHz internet, near-field communication, Z-Wave, Zigbee, etc. The multimedia modifying client 122 is described in greater detail with respect to FIG. 2.

In the exemplary embodiments, the multimedia modifying server 130 may include one or more multimedia modifier models 132 and a multimedia modifier 134, and may act as a server in a client-server relationship with the multimedia modifying client 122. The multimedia modifying server 130 may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of receiving and sending data to and from other computing devices. While the multimedia modifying server 130 is shown as a single device, in other embodiments, the multimedia modifying server 130 may be comprised of a cluster or plurality of computing devices, working together or working independently. The multimedia modifying server 130 is described in greater detail as a hardware implementation with reference to FIG. 5, as part of a cloud implementation with reference to FIG. 6, and/or as utilizing functional abstraction layers for processing with reference to FIG. 7.

The multimedia modifier models 132 may be one or more algorithms modelling a correlation between one or more features extracted from multimedia and an importance of the one or more features. In the example embodiment, the multimedia modifier models 132 may be generated using machine learning methods, such as neural networks, deep learning, hierarchical learning, Gaussian Mixture modelling, Hidden Markov modelling, K-Means, K-Medoids, Fuzzy C-Means learning, etc., and may include features such as node depth, word count, linkage, tone, inflection, delay, repetition, facial expression, eye contact, body movement, etc. The multimedia modifier models 132 may weight the features based on an effect that the features have on the importance of the multimedia such that features determined to be more associated with the importance of the multimedia are weighted more than those that are not. The multimedia modifier models 132 are described in greater detail with reference to FIG. 2.

In the exemplary embodiments, the multimedia modifier 134 may be a software and/or hardware program capable of receiving a configuration, multimedia, and one or more user inputs. The multimedia modifier 134 may be capable of calculating an amount of required multimedia modification based, at least in part, on the user inputs. The multimedia modifier 134 may be further capable of generating a literary parse tree and extracting node features from nodes of the literary parse tree. Moreover, the multimedia modifier 134 may be capable of scoring the nodes of the literary parse tree by applying a model to the features, as well as modifying the multimedia based on the scoring. The multimedia modifier 134 is described in greater detail with reference to FIG. 2.

FIG. 2 depicts an exemplary flowchart 200 illustrating the operations of the multimedia modifier 134 of the multimedia modification system 100 in modifying multimedia, in accordance with the exemplary embodiments.

The multimedia modifier 134 may receive a configuration (step 204). The multimedia modifier 134 may be configured by receiving a user registration and environment configuration. In the example embodiment, the configuration may be received by the multimedia modifier 134 via the multimedia modifying client 122 and the network 108. In embodiments, receiving a user registration may involve receiving demographic information such as a name, username, a type of the smart device 120, a serial number of smart device 120, user calendar, schedule, to-do list, and the like.

The multimedia modifier 134 may further receive an environment configuration during the configuration (step 204 continued). The environment configuration may include receiving a configuration of the smart device 120, for example a smart phone, as well as other devices such as vehicles, laptops, glasses, etc. In addition, the environment configuration may include receiving a configuration of one or more sensors. For example, the environment configuration for a room may include configuring one or more smart devices, such as a smart speaker or video camera.

To further illustrate the operations of the multimedia modifier 134, reference is now made to an illustrative example where a user registers their name and type of smart device 120 via the multimedia modifying client 122 and the network 108. The user also registers a video camera within the environment of the user capable of determining the user's real-time reading speed.

The multimedia modifier 134 may receive at least one multimedia and one or more user inputs (step 206). In embodiments, the multimedia modifier 134 may receive a multimedia file in any manner, for example as an upload/attachment or link/pointer. The multimedia file may be in the form of audio, video, text, etc., and in file formats such as .doc, .docx, .html, .htm, .odt, .pdf, .xls, .xlsx, .ods, .ppt, .pptx, .txt, .wav, .mp3, .mp4, .mov, .mpg, .avi, etc. In some embodiments, rather than receiving previously recorded multimedia, the multimedia modifier 134 may receive multimedia in real time from various sensors of the smart device 120 or environment, such as a microphone, video camera, keyboard, etc. In these embodiments, the multimedia modifier 134 may use audio processing, video processing, and other data processing methods to convert and/or transcribe the real-time recording into a multimedia file, then transfer the multimedia file to the multimedia modifier 134 via the network 108.

In addition to receiving the multimedia, the multimedia modifier 134 may additionally receive user inputs such as a multimedia selection, time limit, and/or reading or play speed (step 206 continued). The multimedia modifier 134 may receive a multimedia selection indicating which portions of the received multimedia are of interest. For example, the multimedia selection may be expressed as the entirety of the multimedia, a percentage of the multimedia, and/or a range of the multimedia (e.g., elapsed time, chapter, page, frame, etc.). In addition to receiving a multimedia selection, the multimedia modifier 134 may also receive a time limit. A time limit describes the amount of time a user is able or wishes to spend experiencing the multimedia file, and may be expressed in hours, minutes, seconds, openings in user schedules, etc. The multimedia modifier 134 may further receive a reading or play speed. A reading or play speed describes the rate at which a user is capable of or wishes to read text, listen to audio, or watch video, and may be expressed in words per minute, chapters per hour, fast-forward speed (2×, 3×, etc.), or any other quantification of data per unit of time. Rather than receiving a read/play speed from the user, in some embodiments, the multimedia modifier 134 may determine a user's reading or play speed based on one or more sensors such as a microphone, video camera, keyboard, etc. For example, a user who does not know their reading speed may be prompted to read a section of text out loud for exactly one minute. The multimedia modifier 134 may use a microphone to count the number of words read out loud by the user to determine an average words read per minute rate for the user. In some embodiments, the multimedia modifier 134 may automate the receival of multimedia and/or one or more user inputs from a user's preferences, calendar, schedule, to-do list, etc. For example, the multimedia modifier 134 may be configured to identify multimedia in a user's to-do list, compare the multimedia-based to-dos to the user's schedule, and determine how much time to allot for the consumption of each multimedia based on available time within the user's schedule.

With reference again to the previously introduced example where the user registers and configures an environment, the user uploads to the multimedia modifier 134 multimedia in the form of a .docx text file, and inputs a multimedia selection of “entirety,” time limit of “2 hours,” and reading speed of “200 words per minute.”

The multimedia modifier 134 may calculate the amount of multimedia modification required (step 208). In the example embodiment, the multimedia modifier 134 may determine the amount of multimedia modification required in order to present the multimedia selection to the user within the time limit specified by the user in the user inputs. The amount of modification may be expressed by a number of words, number of seconds, minutes, hours, etc. of the inputted multimedia to be removed, skipped, fast forwarded, or read, listened to, etc. In some embodiments, the multimedia modifier 134 may determine the amount of modification required by comparing an amount of time needed for the user to experience the unmodified multimedia selection to the user input time limit. For example, the multimedia modifier 134 may first determine an amount of time needed for the user to experience the multimedia selection based on a length of the multimedia selection (e.g., number of words, chapters, time duration, etc.) and the user input reading speed, play speed, etc. If the amount of time needed for the user to experience the unmodified multimedia selection exceeds the user input time limit, the multimedia modifier 134 may determine that modification of the multimedia is required. Alternatively, if the amount of time needed for the user to experience the unmodified multimedia selection is equal to or is less than the user input time limit, the multimedia modifier 134 may notify the user that they are capable of consuming the multimedia in its entirety within the time limit.

Based on determining that modification of the multimedia is necessary, the multimedia modifier 134 may then determine an amount of the unmodified multimedia that the user can complete within the time limit based on the time limit and user reading speed, play speed, etc. (step 208 continued), and further determine an amount of modification required of the unmodified multimedia by subtracting the amount of the unmodified multimedia that the user can complete within the time limit from the length of the multimedia selection, determined above. Accordingly, the resulting difference represents an amount of the unmodified multimedia that needs be modified, e.g., removed, in order for the user to complete the multimedia within the user input time limit.

With reference again to the previously introduced example where the user uploads multimedia in the form of a .docx file, a multimedia selection of “entirety,” a time limit of “2 hours,” and a reading speed of “200 words per minute,” the multimedia modifier 134 determines that there are 27,000 words in the received .docx text file. The multimedia modifier 134 multiplies 200 words per minute (the user's reading speed) by 120 minutes (2 hour time limit) to determine that the user would be able to read approximately 24,000 words in 2 hours. The multimedia modifier 134 subtracts 24,000 words from 27,000 words to further determine that the received multimedia requires 3,000 words to be trimmed from the received .docx text file.

The multimedia modifier 134 may generate one or more literary parse trees based on the received multimedia (step 210). As previously discussed, the received multimedia may be in the form of a file, and may be audio, video, text, etc. In embodiments where the multimedia is audio, video, or otherwise does not include structured text, the multimedia modifier 134 may first record, transcribe, translate, recognize optical characters of, etc. the multimedia such that text may be extracted. The multimedia modifier 134 may then use training data along with probabilistic context-free approaches such as probabilistic context-free grammars, maximum entropy, and neural nets to generate literary parse trees for the text in the received multimedia. The generated literary parse trees may be in the form of dependency-based parse trees or any other forms of organizing natural language into nodes. For example, a generated literary parse tree for a fiction novel may involve organizing text by nodes: setting, theme, plot, resolution, etc. such that text supporting a main idea may be depicted as a node that branches off of the main idea. The main theme of the novel may be a node that is supported by three messages throughout the novel, which may be depicted as nodes that branch off of the main theme. Each of the three nodes for the three messages may be supported by two examples, which may be depicted as nodes that branch off of the three messages. In other embodiments, the literary parse tree may organize root nodes, child nodes, and linkages based on other relationships aside from those listed above, such as topic and subtopic.

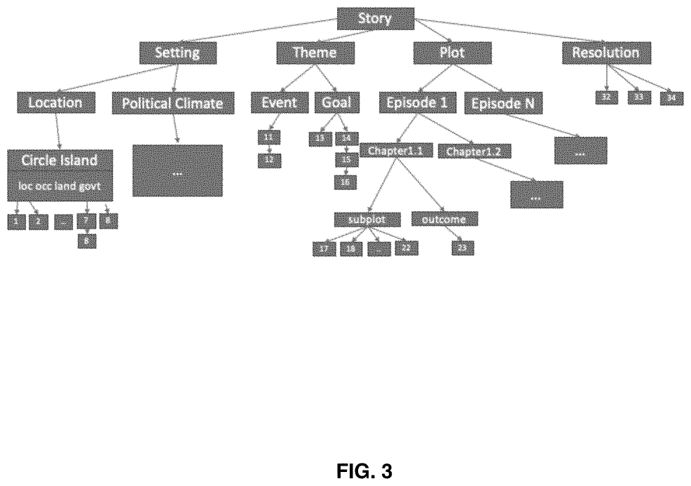

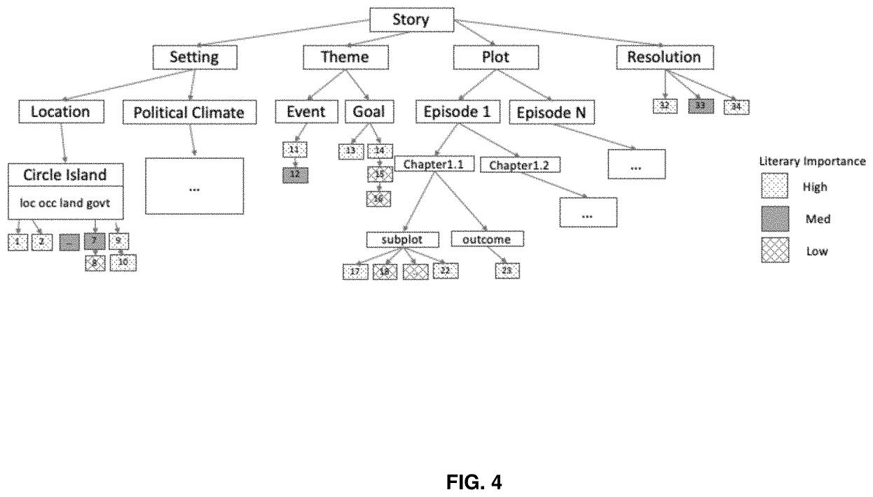

Returning again to the previously introduced example where the multimedia modifier 134 determines that 3,000 words need to be trimmed from the received multimedia file, reference is now made to FIG. 3-4 wherein the multimedia modifier 134 generates a literary parse tree for the entirety of the received .docx text file.

The multimedia modifier 134 may extract node features (step 212). Such features may be extracted from the generated literary parse tree, and may include node depth, word count, linkage, tone, inflection, delay, repetition, facial expression, eye contact, body movement, etc. With respect to node depth, the multimedia modifier 134 may extract a node depth by determining how many nodes are branched off of each node. In embodiments, the multimedia modifier 134 may only consider direct nodes branched off of a root node in counting a root node's node depth. In other embodiments, the multimedia modifier 134 may count the number of all direct and/or indirect nodes branched off of a root node towards the root node's node depth. For example, and in accordance with the latter methodology, the multimedia modifier 134 may determine that a main idea node with two main point nodes branching off of it, and three example nodes branching off of each main point node has a node depth of eight based on the sum of the single main idea node, two main point nodes, and both sets of the three example nodes.

In addition to extracting node depth, the multimedia modifier 134 may also extract a node word count and redundancy feature by determining an amount of words the multimedia uses to convey a node (step 212 continued). In embodiments, the word count feature may be indicative of an importance of a node, with a higher word count indicative of a greater importance and, therefore, the multimedia modifier may consider a node having a high word count a less appropriate candidate for modification of corresponding multimedia. Conversely, however, a node having a higher word count with high redundancy may be a more appropriate candidate for modification due to excessive repetition. Moreover, redundant concepts may be found within a child node of the root node, as well. Accordingly, the multimedia modifier 134 may be configured to identify both word counts and redundancies within the root and child nodes when determining a word count corresponding to a node, which may be weighed accordingly by the model described herein. In the example embodiment, redundant concepts may be determined through means such as topic modeling, keyword counts, syntax analysis, semantic analysis, natural language processing, etc., and in embodiments having redundancies, the multimedia modifier 134 may be configured to modify the multimedia such that at least one instance of the redundant information remains unmodified.

In addition to extracting a word count, the multimedia modifier 134 may also extract a node linkage by determining how many other nodes in the generated literary parse tree with which the node has a linked relationship (step 212 continued). In embodiments, the multimedia modifier 134 may analyze literary parse trees to determine that second tier nodes branched off of a first tier node, as well as third tier nodes branched from the second tier node, etc., are linked to the first tier nodes. In other embodiments, the multimedia modifier 134 may determine that subject-object linkage, subject-verb-object linkage, or other contextual linkages or contextual dependencies constitute linkage relationships. For example, the multimedia modifier 134 may determine that a main idea node with three subject-object linkages to other main idea nodes has a linkage of three.

In addition to extracting a linkage, the multimedia modifier 134 may also extract a tone, inflection, delay, repetition, and any other audio characteristics indicative of importance by analyzing the received multimedia for audio indications of importance, when applicable (step 212 continued). For example, the multimedia modifier 134 may determine that a section of an audio lecture with a professor stressing the importance of the section with high inflection, long delay, and high repetition has high inflection, delay, and repetition. Moreover, in embodiments, the multimedia modifier may further analyze textual multimedia and audio, video, etc. multimedia that has been processed via natural language processing methods into textual multimedia, for words or phrases such as “this is very important,” “this is not that crucial,” “this is my favorite part,” and any other characteristics indicative of tone, inflection, delay, or repetition.

In addition to extracting a tone, inflection, delay, or repetition, the multimedia modifier 134 may also extract a facial expression, eye contact, body movement, and any other visual characteristics indicative of importance by analyzing received multimedia for video indications of importance (step 212 continued). For example, the multimedia modifier 134 may determine that a section of a video lecture with a professor smiling, sustaining eye contact with the video camera, and waving their arms has high facial expression, eye contact, and body movement. In other embodiments, the multimedia modifier 134 may utilize one or more sensors to detect a facial expression, eye contact, body movement, and any other visual characteristics indicative of importance.

With reference again to the previously introduced example illustrated by FIG. 3-4 where the multimedia modifier 134 generates a literary parse tree for the received multimedia file, the multimedia modifier 134 extracts node features for node depth, word count, linkage, tone, inflection, delay, repetition, facial expression, eye contact, and body movement for each node in the literary parse tree.

The multimedia modifier 134 may apply one or more models to the extracted features (step 214). In embodiments, the multimedia modifier 134 may apply the one or more multimedia modifier models 132 to the extracted features to compute node importance scores. As previously mentioned, such extracted features may include node depth, word count, linkage, tone, inflection, delay, repetition, facial expression, eye contact, body movement, etc., and the one or more multimedia modifier models 132 may be generated through machine learning techniques such as neural networks. Moreover, the multimedia modifier 134 may weight the extracted features. In embodiments, the one or more multimedia modifier models 132 may be trained at initialization and/or during operation through the use of a feedback loop to weight the features such that features shown to have a greater correlation with the importance of a literary parse tree node are weighted greater than those features that are not. Based on the features identified in the nodes and the weightings assigned by the multimedia modifier models 132, the multimedia modifier 134 may determine importance scores for each of the nodes identified within the generated literary parse tree. For example, the features and weights may be represented by numeric values and the multimedia modifier 134 may multiply identified features by the weights to compute a feature score for each feature extracted from a node of a generated literary parse tree. The multimedia modifier 134 may then sum the feature scores to compute an importance score for one or more of the nodes.

With reference again to the previously introduced example illustrated by FIG. 3-4, where the multimedia modifier 134 extracts node features for node depth, word count, linkage, tone, inflection, delay, repetition, facial expression, eye contact, and body movement for each node in the literary parse tree, the multimedia modifier 134 applies a model to determine literary importance scores of low, medium, and high for all nodes on the generated literary parse tree.

The multimedia modifier 134 may modify the received multimedia (step 216). The multimedia modifier 134 may modify the received multimedia by modifying the multimedia in sections corresponding to the one or more nodes having a lowest importance score based on the amount of multimedia modification required, which may include trimming, skipping, fast forwarding, etc. The multimedia modifier 134 may compare an importance score of a node with importance scores of other nodes, with nodes with lower importance scores prioritized for the modification, e.g., trimming, of multimedia. In other embodiments, an importance score for a node may be compared to a threshold, with nodes with scores not exceeding the threshold identified as nodes to be trimmed for multimedia modification. For example, the multimedia modifier 134 may identify nodes having an importance score not exceeding a threshold of 30% as nodes to be trimmed during multimedia modification. The multimedia modifier 134 may trim nodes by deleting their corresponding text, audio, or video from the received multimedia until the amount of multimedia modification determined earlier by the multimedia modifier 134 has been removed from the unmodified multimedia. In embodiments, after modifying the received multimedia, the multimedia modifier 134 may iterate steps 206 through 216 for the same received multimedia or for a newly received multimedia. In some embodiments, the multimedia modifier 134 may iterate steps 206 through 216 until the same inputted multimedia selection has been completely consumed by the user or the inputted time limit has expired. In some embodiments, the multimedia modifier 134 may iterate steps 206 through 216 using a real-time input value for a user's reading or play speed from one or more sensors to more accurately modify the user's multimedia. Such embodiments may be advantageous for information-dense multimedia or distracted users in that the multimedia modifier 134 may adapt to a user read or play speed in real time. Accordingly, the multimedia modifier 134 may modify an amount of modification required based on detecting a slowing of user reading or replay speed, a selection of replay or rewind of the multimedia, etc. In other embodiments, the multimedia modifier 134 may cease multimedia modification after the first iteration of modifying multimedia.

With reference again to the previously introduced example illustrated by FIG. 3-4, where the multimedia modifier 134 generates literary importance scores of low, medium, and high for each node on the generated literary parse tree, the multimedia modifier 134 deletes nodes 8, 15, 16, 18, 19, 20, and 21 (nodes having low importance scores) to delete the 3,000 words necessary. The multimedia modifier 134 then iterates the completed process of modifying multimedia to adapt to the user's reading speed in real time.

FIG. 3 depicts an illustrative example of a literary parse tree generated by the multimedia modification system 100 based on received multimedia, in accordance with the exemplary embodiments.

FIG. 4 depicts an illustrative example of the literary parse tree in which the multimedia modifier 134 has assigned nodes importance scores, in accordance with the exemplary embodiments.

FIG. 5 depicts a block diagram of devices within the multimedia modifier 134 of FIG. 1, in accordance with the exemplary embodiments. It should be appreciated that FIG. 5 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 40 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 6) is shown. It should be understood in advance that the components, layers, and functions shown in FIG. 7 are intended to be illustrative only and the exemplary embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and multimedia modification 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for modifying multimedia, the method comprising:
receiving a multimedia and one or more inputs;
determining a required amount of modification to the multimedia based on the one or more inputs;
generating a literary parse tree based on the multimedia;
extracting one or more node features from one or more nodes of the parse tree;
determining a node importance of the one or more nodes based on applying a model to the one or more node features; and
modifying one or more portions of the multimedia corresponding to the one or more nodes based on the node importance and the required amount of multimedia modification.

2. The method of claim 1, wherein the one or more models correlate the one or more node features with the node importance.

3. The method of claim 1, wherein the one or more inputs include a length of the multimedia, a time limit to experience the multimedia, and at least one of a reading speed and a playing speed of a user.

4. The method of claim 3, wherein determining the amount of multimedia modification required further comprises:
determining an amount of the multimedia that the user can experience within the time limit based on the length of the multimedia and at least one of the reading speed and the playing speed of the user; and
subtracting the amount of the multimedia that the user can experience within the time limit from the length of the multimedia.

5. The method of claim 1, wherein modifying the multimedia further comprises:
an action selected from a group comprising skipping, removing, and fast forwarding the one or more portions of the multimedia.

6. The method of claim 1, wherein the one or more features include features selected from a group comprising node depth, word count, linkage, tone, inflection, delay, repetition, facial expression, eye contact, and body movement.

7. The method of claim 1, further comprising:
receiving one or more updated inputs based on one or more sensors;
detecting a change between the one or more inputs and the one or more updated inputs; and
modifying the multimedia based on the detected change.

8. A computer program product for modifying multimedia, the computer program product comprising:
one or more non-transitory computer-readable storage media and program instructions stored on the one or more non-transitory computer-readable storage media capable of performing a method, the method comprising:
receiving a multimedia and one or more inputs;
determining a required amount of modification to the multimedia based on the one or more inputs;
generating a literary parse tree based on the multimedia;
extracting one or more node features from one or more nodes of the parse tree;
determining a node importance of the one or more nodes based on applying a model to the one or more node features; and
modifying one or more portions of the multimedia corresponding to the one or more nodes based on the node importance and the required amount of multimedia modification.

9. The computer program product of claim 8, wherein the one or more models correlate the one or more node features with the node importance.

10. The computer program product of claim 8, wherein the one or more inputs include a length of the multimedia, a time limit to experience the multimedia, and at least one of a reading speed and a playing speed of a user.

11. The computer program product of claim 10, wherein determining the amount of multimedia modification required further comprises:
determining an amount of the multimedia that the user can experience within the time limit based on the length of the multimedia and at least one of the reading speed and the playing speed of the user; and
subtracting the amount of the multimedia that the user can experience within the time limit from the length of the multimedia.

12. The computer program product of claim 8, wherein modifying the multimedia further comprises:
an action selected from a group comprising skipping, removing, and fast forwarding the one or more portions of the multimedia.

13. The computer program product of claim 8, wherein the one or more features include features selected from a group comprising node depth, word count, linkage, tone, inflection, delay, repetition, facial expression, eye contact, and body movement.

14. The computer program product of claim 8, further comprising:
receiving one or more updated inputs based on one or more sensors;
detecting a change between the one or more inputs and the one or more updated inputs; and
modifying the multimedia based on the detected change.

15. A computer system for modifying multimedia, the computer system comprising:
one or more computer processors, one or more computer-readable storage media, and program instructions stored on the one or more of the computer-readable storage media for execution by at least one of the one or more processors capable of performing a method, the method comprising:
receiving a multimedia and one or more inputs;
determining a required amount of modification to the multimedia based on the one or more inputs;
generating a literary parse tree based on the multimedia;
extracting one or more node features from one or more nodes of the parse tree;
determining a node importance of the one or more nodes based on applying a model to the one or more node features; and
modifying one or more portions of the multimedia corresponding to the one or more nodes based on the node importance and the required amount of multimedia modification.

16. The computer system of claim 15, wherein the one or more models correlate the one or more node features with the node importance.

17. The computer system of claim 15, wherein the one or more inputs include a length of the multimedia, a time limit to experience the multimedia, and at least one of a reading speed and a playing speed of a user.

18. The computer system of claim 17, wherein determining the amount of multimedia modification required further comprises:
determining an amount of the multimedia that the user can experience within the time limit based on the length of the multimedia and at least one of the reading speed and the playing speed of the user; and
subtracting the amount of the multimedia that the user can experience within the time limit from the length of the multimedia.

19. The computer system of claim 15, wherein modifying the multimedia further comprises:
an action selected from a group comprising skipping, removing, and fast forwarding the one or more portions of the multimedia.

20. The computer system of claim 15, wherein the one or more features include features selected from a group comprising node depth, word count, linkage, tone, inflection, delay, repetition, facial expression, eye contact, and body movement.
